(19) United States
(12) Patent Application Publication
(10) Pub. No.: US 2016/0129537 A1
(43) Pub. Date: May 12, 2016

(54) BASIC BODY OF MAGNETIC CLAMPING PLATE AND METHOD OF PRODUCTION THEREOF

(71) Applicant: Bruck AM spol. s.r.o., Zamrsk (CZ)

(72) Inventors: Vaclav Horacek, Litomysl (CZ); Lubos Maly, Vysoke Myto (CZ)

(73) Assignee: Bruck AM spol. s.r.o., Zamrsk (CZ)

(21) Appl. No.: 14/892,609

(22) PCT Filed: May 21, 2014
(86) PCT No.: PCT/CZ2014/000057

§ 371 Date: Nov. 20, 2015

(30) Foreign Application Priority Data
May 27, 2013 (CZ) PV2013-391

(51) Int. Cl. B23Q 3/152; B21H 1/04; B21K 1/32; B21J 5/00

(52) U.S. Cl. CPC B23Q 3/152; B21J 5/002; B21H 1/04; B21K 1/32

(57) ABSTRACT

The basic body of the magnetic clamping plate, particularly the basic body (1) of the radial magnetic clamping plate, which contains of at least one annulus (2) that is seamless, rolled, and forged. The method of production of the basic body of the magnetic clamping plate, particularly method of production of the basic body of the radial magnetic clamping plate, where semi-finished product of at least one annulus (2) is created first by rolling and/or forging with subsequent machining, whereas in case the basic body (1) of the magnetic clamping plate contains of at least two annuluses (2), the semi-finished product is machined so that technological shape and size of the annulus (2) are created, whereas both annuluses (2) are arranged so that they are mutually connected.

### TECHNICAL FIELD

The invention relates to the basic body of a magnetic clamping plate, more particularly to the basic body of a radial magnetic clamping plate and method for production thereof.

### STATE OF THE ART

Large machine tools, which include magnetic clamping plates used for clamping of machined components, are known in the art. In case the machine tools are used for production of rotary products, radial magnetic clamping plates are used in some cases. These radial magnetic clamping plates consist of the basic body and magnetic clamping system located thereon.

According to known art, the basic bodies of the radial magnetic clamping plate are manufactured as baked items from metal plates. In case of production of the basic bodies of diameters usually over 2500 mm, the basic body consists of multiple baked items that are mutually welded or assembled in shape of machine table on the foundation plate. Resulting weld joint of multiple baked items is machined to final dimension of the basic body of the radial magnetic clamping plate.

Disadvantage of the basic bodies manufactured in this way is that they must be appropriately dimensioned with respect to used semi-finished product and required properties, which means rather large dimensions and thereby high weight. This also increases requirements for construction of the full machine tool, particularly for driving mechanisms. Another disadvantage of the welded basic plates is that they may cause inhomogeneity of magnetic field of the clamping plate, which may result from the difference of electrode material and local thermal load in parts of welds, which are not spaced uniformly along perimeter of the structure.

The aim of the invention is a structure of the basic body of the clamping plate of reduced dimensions and thereby reduced weight while retaining or improving mechanical properties, whereas the basic plate will be of homogenous properties and will not breach homogeneity of magnetic field created by the magnetic clamping system.

### PRINCIPLE OF THE INVENTION

These disadvantages are largely eliminated and aims of the invention are accomplished by the basic body of the magnetic clamping plate, particularly the basic body of the radial magnetic clamping plate of the invention, where it contains at least one annulus that is seamless rolled with certain level of overlap forging.

According to another embodiment of the invention, said disadvantages are largely eliminated and aims of the invention are accomplished by the basic body of the magnetic clamping plate, particularly the basic body of the radial magnetic clamping plate of the invention, essence of which lies in the fact that it contains at least one annulus that is forged with certain level of overlap forging.

According to last embodiment of the invention, said disadvantages are largely eliminated and aims of the invention are accomplished by the basic body of the magnetic clamping plate, particularly the basic body of the radial magnetic clamping plate of the invention, essence of which lies in the fact that it contains at least one annulus that is seamless forged with certain level of overlap forging.

The benefit of all three embodiments is that the annulus material fibres are arranged regularly in ring-shaped arrangement, which means substantially improved mechanical properties of the basic body of the magnetic clamping plate both in case it is made from one annulus as well as in case that at least two annuluses.

Assembly of the clamping plate of multiple annuluses is especially preferred in case of clamping plates of large dimensions; however, it may be used for clamping plates of smaller dimensions as well. The basic body of the magnetic clamping plate then contains at least two mutually connected annuluses mentioned above, whereas the annuluses may be mutually connected with flush joint or recessed joint that contains at least one recess. Favourable for the recessed joint connection is that the connection produces a shaped joint, which allows simplification of radial and axial setting of mutual position of both annuluses.

The connections are favourably made with radial interference, whereas radial interference of pressing the annulus by hot extrusion seems to be the most favourable. In another embodiment, both annuluses may be connected by cold extrusion.

It is favourable for both the annuluses to be also connected by welding. The welding may be spot welding. Continuous welding along the circumference is the most favourable. The connection described above, which is optionally welded, guarantees homogeneous mechanical and electromagnetic properties of the clamping plate. In addition, the clamping plate may be of subtle structure, which results in high material savings and significant reduction of production costs.

Favourable is also when at least one annulus has on its edge at least one external recess, which first increases rigidity of the whole clamping plate, and second, it is part of the edging of bedding of the magnetic clamping system.

Favourably, the basic body of the magnetic clamping plate is repeatedly heat treated during production in order to improve precision of production and shape and dimension stability during its lifecycle.

Disadvantages of the art mentioned above are largely eliminated by the method of production of the basic body of the magnetic clamping plate, particularly the method of production of said basic body of the radial magnetic clamping plate of the invention, where semi-finished product of at least annulus used for further machining is first prepared by rolling and/or forging.

Favourably, the semi-finished product of the annulus is heat treated before machining, and most favourably, the semi-finished product is annealed. Hence, machining will be simplified and improved accuracy of the final work piece is achieved.

If the clamping plate contains of at least two annuluses, the semi-finished product is then favourably machined to create technological shape and dimension of the annulus, whereas both annuluses are arranged so that they are mutually connected.

Most favourably, mutual connection of both annuluses is made under heat treatment with radial overlap. In another embodiment, both annuluses may be cold pressed on each other. In both cases, mutual pressure connection with overlap will be produced.

Favourably, the connection of the annuluses is welded favourably from at least one side and at least on part of circumference,

The most favourable fact of the basic body of the magnetic clamping plate of the invention is that—thanks to its production from rolled and/or forged annuluses—it provides homogenous structure and thus, it offers better mechanical and electromagnetic properties compared to the known art. In general, it has higher strength and rigidity at identical or lower weight. Also in case the magnetic clamping plate contains of at least two annuluses, the assembly has mechanical and physical properties as a single compact piece.

Further benefits compared to the art are clear from the description above. Rolled and then baked metal plates according to known art has fibre structure corresponding to continuous rolling, i.e. any further machining disrupts internal structure and direction of the fibres with negative impact on mechanical properties of the structure, rigidity of which is different in the rolling direction when compared to rigidity in axis direction rotated by 90° from the rolling direction. Structure of fibres of the clamping plate of the invention is uniformly circular, whereas no further machining may disrupt the same. Thus, homogeneous properties mentioned above are achieved regardless stress direction of the clamping plate. This definitely results in improved flexural rigidity and torsion stiffness of the clamping plate of the invention, which are guaranteed not only by mechanical design as well as material with certain level of overlap forging, not offered by baked metal sheet. The final result is substantially higher stability of the machine—work piece—die system. At the same time, higher machining speed and higher quality processing of work pieces are achieved while improving durability of dies. Use of the clamping plate of the invention can streamline production up to 25%.

Structure of the clamping plate of the invention brings benefits from electromagnetic point of view as well. Connections of the annulus and their potential welds are spaced evenly along the structure circumference. This embodiment does not disrupt homogeneity of magnetism created by magnetic clamping system.

In addition, it is clear from the facts mentioned above that the clamping plate allows due to its subtle structure to achieve high material saving and thereby, significant reduction of production costs.

### OVERVIEW OF THE FIGURES

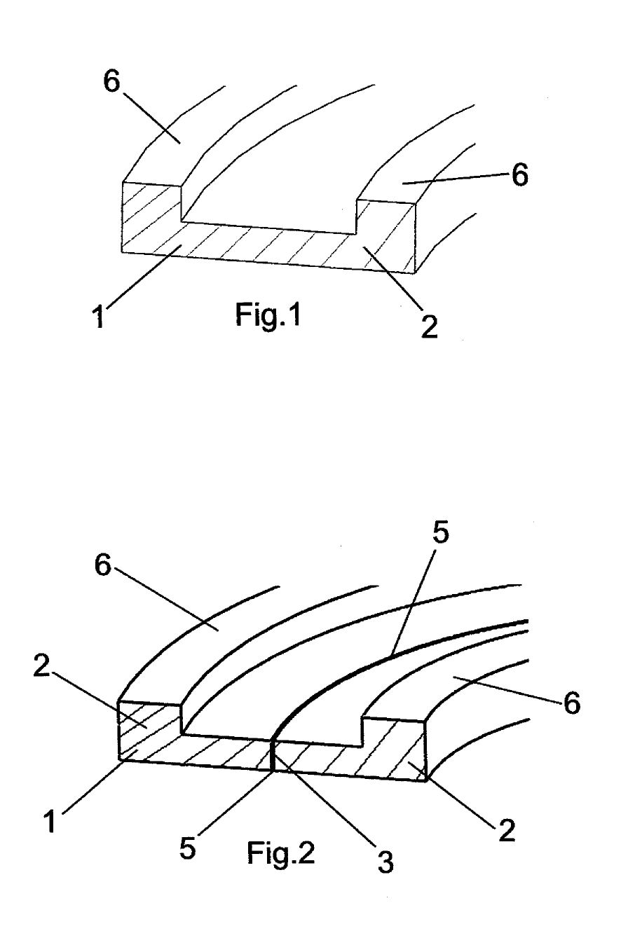

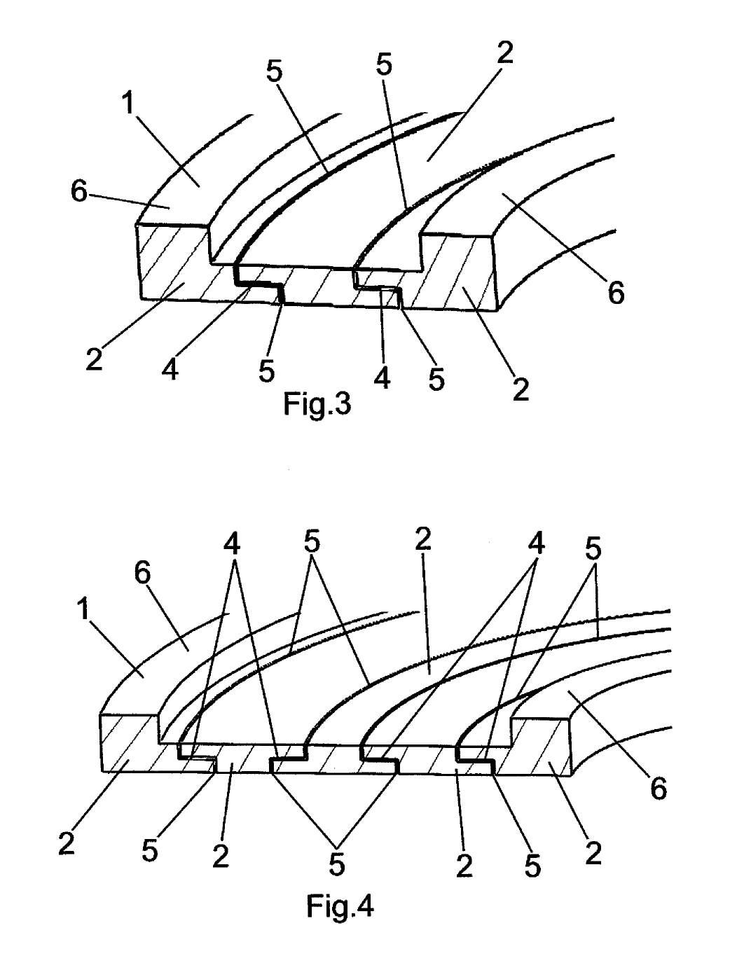

The invention will be more explained by the drawing, where FIG. 1 illustrates cross section of the basic body of the magnetic clamping plate consisting of one annulus, FIG. 2 illustrates cross section of the basic body of the magnetic clamping plate consisting of two annuluses, FIG. 3 illustrates cross section of the basic body of the magnetic clamping plate consisting of three annuluses, and FIG. 4 illustrates cross section of the basic body of the magnetic clamping plate consisting of five annuluses.

### EXAMPLES OF THE PERFORMANCE OF THE INVENTION

### Example 1

The basic body 1 (FIG. 1) of the magnetic radial clamping plate contains one annulus 2 that is seamless, rolled, and heat treated.

The annulus 2 has external recesses 6 on its edge.

According to the method of production of the basic body 1 of the magnetic clamping plate, semi-finished product of the annulus 2 is prepared first with subsequent heat treatment by annealing. Finally, the semi-finished product of the annulus 2 is machined to a final dimension.

### Example 2

The basic body 1 (FIG. 2) of the magnetic radial clamping plate contains two mutually connected annuluses 2, of which one is seamless and rolled and the other is forged. Both annuluses 2 are heat treated by annealing.

The annuluses 2 are mutually connected by flush joint 3 with radial overlap.

The annuluses 2 are then mutually connected by weld joints 5 arranged on edges of the connection 3 of both annuluses 2.

Both annuluses 2 have external recesses 6 on their external edges.

According to the method of production of the basic body 1 of the radial magnetic clamping plate, semi-finished product of the first annulus 2 is created by rolling and semi-finished product of the second annulus 2 is created by forging. Both semi-finished products of the annulus 2 are then heat treated by annealing.

Then, both semi-finished products of the annulus 2 are machined so that their technological shapes and dimensions are made and ready for mutual connection.

Both annuluses 2 are consequently cold placed with radial overlap so that they are mutually connected.

Then, the connection 3 of the annuluses 2 is welded 5 on both sides and along its circumference.

Produced semi-finished product of the basic body 1 is then heat treated by annealing.

Finally, the semi-finished product of the basic body 1 is machined to the final dimension of the basic body 1 coated with surface treatment by zinc or nickel coating.

### Example 3

The basic body 1 (FIG. 3) of the magnetic radial clamping plate contains three mutually connected annuluses 2, of which one is seamless and rolled, the second is forged, and the third is seamless, rolled, and forged. All annuluses 2 are heat treated.

The annuluses 2 are mutually connected with joints 4 with radial overlap with one recess each.

The annuluses 2 are also mutually connected by weld joints 5 arranged on edges of the connection 4 of all three annuluses 2.

The extreme annuluses 2 have external recesses 6 on their external edges.

According to the method of production of the basic body 1 of the magnetic clamping plate, semi-finished product of the first annulus 2 is created by rolling, semi-finished product of the second annulus 2 is created by forging, and the semi-finished product of the third annulus 2 is created alternatively by rolling and forging. All semi-finished products of the annulus 2 are then heat treated by annealing.

Then, all semi-finished products of the annulus 2 are machined so that their technological shapes and dimensions are made and ready for mutual connection.

Subsequently, first two annuluses 2 are hot deposited with radial overlap so that they are mutually connected, and third annulus 2 is then connected in the identical manner.

Then, the connections 4 of the annuluses 2 are welded 5 on both sides and along their circumference.

Produced semi-finished product of the basic body 1 is then heat treated by annealing.

Finally, the semi-finished product of the basic body 1 is machined to the final dimension of the basic body 1 coated with surface treatment by zinc coating.

### Example 4

The basic body 1 (FIG. 4) of the radial magnetic clamping plate contains five mutually connected annuluses 2, whereas they are seamless rolled and heat treated.

The annuluses 2 are mutually connected with joints 4 with radial overlap with one recess each.

The annuluses 2 are also mutually connected by weld joints 5 arranged on edges of the connections 4 of all five annuluses 2.

The extreme annuluses 2 have arranged external recesses 6 on their external edges.

According to the method of production of the basic body 1 of the radial magnetic clamping plate, semi-finished products of all annuluses 2 are created with subsequent heat treatment of the semi-finished products of annuluses 2 by annealing.

Then, all semi-finished products of the annulus 2 are machined so that their technological shapes and dimensions are made and ready for mutual connection.

Subsequently, first two annuluses 2 are hot deposited with radial overlap so that they are mutually connected, and other annuluses 2 are then connected in the identical manner.

Then, the connections 4 of the annuluses 2 are welded 5 on both sides and along their circumference.

Produced semi-finished product of the basic body 1 is then heat treated by annealing.

Finally, the semi-finished product of the basic body 1 is machined to the final dimension of the basic body 1 coated with surface treatment by zinc or nickel coating.

### INDUSTRIAL APPLICATION

The basic body of the magnetic clamping plate, particularly the basic body of the radial magnetic clamping plate, can be used as the basic supporting part of work pieces machined on the machine tools such as carousels, horizontal lathes, mills, drills, and machining centres.

### LIST OF REFERENCE MARKS

1 basic body

2 annulus

3 flush joint

4 recessed joint

5 weld joint

6 external recess

1. A basic body of a magnetic clamping plate, particularly the basic body of the radial magnetic clamping plate, wherein it contains at least one annulus that is seamless and rolled.

2. A basic body of a magnetic clamping plate, particularly the basic body of the radial magnetic clamping plate, wherein it contains at least one annulus that is forged.

3. The basic body of the magnetic clamping plate according to claim 1, wherein the at least one annulus that is seamless, rolled, and forged.

4. The basic body of the magnetic clamping plate according to claim 1, wherein it contains at least two mutually connected annuluses.

5. The basic body of the magnetic clamping plate according to claim 1, wherein it contains at least two annuluses mutually connected with a flush joint.

6. The basic body of the magnetic clamping plate according to claim 1, wherein it contains at least two annuluses mutually connected with a recessed joint, which contains at least one recess.

7. The basic body of the magnetic clamping plate according to claim 1, wherein it contains at least two mutually connected annuluses, which are mutually connected with radial overlap.

8. The basic body of the magnetic clamping plate according to claim 1, wherein it contains at least two mutually connected annuluses, which are mutually connected with a weld joint.

9. The basic body of the magnetic clamping plate according to claim 1, wherein at least one annulus has at least one external recess arranged on its edge.

10. The basic body of the magnetic clamping plate according to claim 1, wherein it is heat treated.

11. A method of production of the basic body of the magnetic clamping plate, particularly method of production of the basic body of the radial magnetic clamping plate according to claim 1, wherein the semi-finished product of at least one annulus is created first by rolling and/or forging with subsequent machining.

12. The method of production of the basic body of the magnetic clamping plate according to claim 12, wherein the semi-finished product of the annulus is heat treated before machining.

13. The method of production of the basic body of the magnetic clamping plate according to claim 12, wherein the semi-finished product of at least two annuluses is subsequently machined so that technological shape and size of the annulus are created, whereas both annuluses are arranged so that they are mutually connected.

14. The method of production of the basic body of the magnetic clamping plate according to claim 13, wherein the annuluses are hot placed or cold placed with radial overlap.

15. The method of production of the basic body of the magnetic clamping plate according to claim 13, wherein the individual annuluses are mutually arranged and their connection is then welded with a weld joint at least from one side and at least on a part of circumference.
